(19) United States
(12) Patent Application Publication
(10) Pub. No.: US 2022/0309379 A1
(43) Pub. Date: Sep. 29, 2022

(54) Automatic Identification of Improved Machine Learning Models

(71) Applicant: International Business Machines Corporation, Armonk, NY (US)

(72) Inventors: Indervir Singh Banipal, Austin, TX (US); Shikhar Kwatra, San Jose, CA (US); Vinod A. Valecha, Pune (IN); Gandhi Sivakumar, Bentleigh (AU)

(21) Appl. No.: 17/205,763

(22) Filed: Mar. 18, 2021

(51) Int. Cl. G06N 20/00; G06N 5/04

(52) U.S. Cl. CPC G06N 20/00; G06N 5/04

(57) ABSTRACT

Identifying new machine learning models with improved metrics is provided. A new machine learning model is searched for that is relevant to a current machine learning model running within a client device and has improved metrics over current metrics of the current machine learning model. It is determined whether a relevant new machine learning model having improved metrics over the current metrics of the current machine learning model was found in the search. In response to determining that a relevant new machine learning model having improved metrics was found in the search, it is determined whether the relevant new machine learning model is compatible with the current machine learning model. In response to determining that the relevant new machine learning model is compatible with the current machine learning model, the relevant new machine learning model is automatically implemented in the client device.

### BACKGROUND

### 1. Field

The disclosure relates generally to artificial intelligence and more specifically to automatically identifying new machine learning models with improved metrics for a user's data processing system to increase performance.

### 2. Description of the Related Art

Artificial intelligence is an ability of a data processing system, such as a computer system, to perform tasks commonly associated with human intelligence, such as visual perception, speech recognition, textual recognition, decision-making, and the like. Artificial intelligence comprises at least one of an artificial neural network, cognitive system, Bayesian network, fuzzy logic, expert system, natural language system, or some other suitable system.

Machine learning is also a fundamental concept of artificial intelligence. Machine learning improves automatically through experience. Machine learning involves inputting data to the process and allowing the process to adjust and improve the function of artificial intelligence, thereby increasing the predictive accuracy of artificial intelligence and, thus, increasing the performance of the data processing system, itself.

A machine learning model can learn without being explicitly programmed to do so. The machine learning model can learn using various types of machine learning algorithms. Machine learning algorithms include at least one of supervised learning, semi-supervised learning, unsupervised learning, feature learning, sparse dictionary learning, anomaly detection, association rules, or other types of learning algorithms. Examples of machine learning models include an artificial neural network, a decision tree, a support vector machine, a Bayesian network, a genetic algorithm, and other types of models.

### SUMMARY

According to one illustrative embodiment, a computer-implemented method for identifying new machine learning models with improved metrics is provided. A computer searches for a new machine learning model that is relevant to a current machine learning model running on a data set within a client device of a user and that has improved metrics over current metrics of the current machine learning model. The computer determines whether a relevant new machine learning model having improved metrics over the current metrics of the current machine learning model was found in the search. In response to the computer determining that a relevant new machine learning model having improved metrics over the current metrics of the current machine learning model was found in the search, the computer determines whether the relevant new machine learning model is compatible with the current machine learning model. In response to the computer determining that the relevant new machine learning model is compatible with the current machine learning model, the computer automatically implements the relevant new machine learning model having the improved metrics in the client device of the user to increase performance of the client device. According to other illustrative embodiments, a computer system and computer program product for identifying new machine learning models with improved metrics are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented; and

FIG. 3 is a flowchart illustrating a process for identifying new machine learning models with improved metrics in accordance with an illustrative embodiment.

### DETAILED DESCRIPTION

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

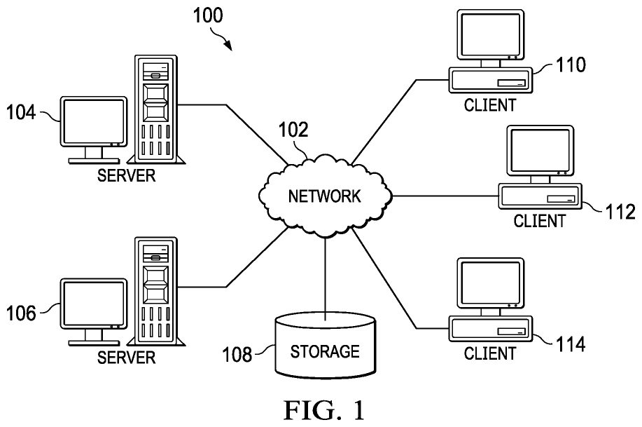

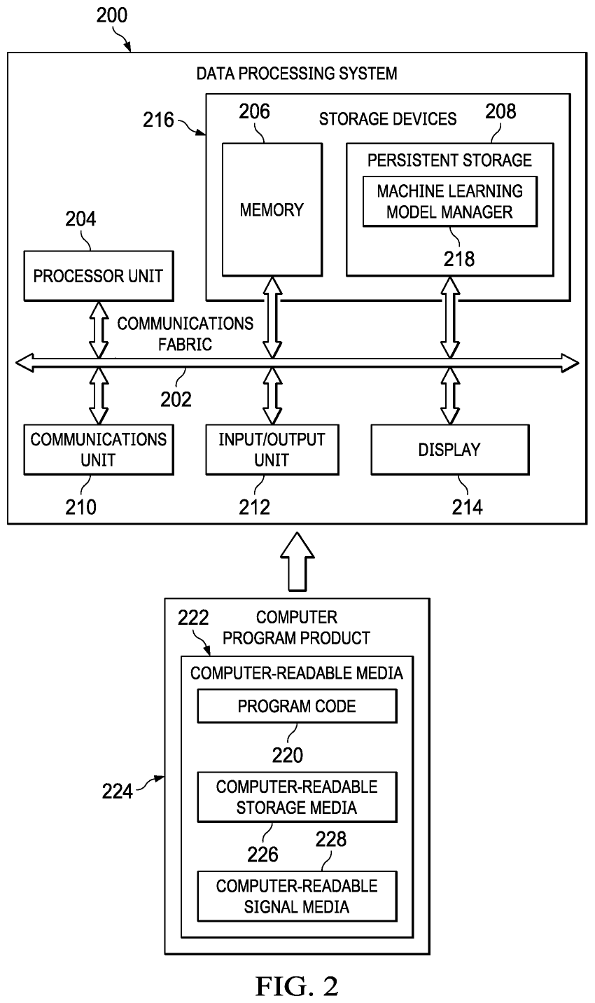

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, server computers with high-speed connections to network 102. In addition, server 104 and server 106 provide machine learning model management services to client devices of subscribing users by automatically identifying new machine learning models with improved metrics as compared to current metrics of current machine learning models running on data sets within the client devices. Server 104 and server 106 may automatically implement a new machine learning model with improved metrics when the new machine learning model is compatible with the current machine learning model and corresponding client device or may send a recommendation to a subscribing user that a new machine learning model with improved metrics is available for implementation. Also, it should be noted that server 104 and server 106 may each represent a cluster of servers in one or more data centers. Alternatively, server 104 and server 106 may each represent multiple computing nodes in one or more cloud environments.

Client 110, client 112, and client 114 also connect to network 102. Clients 110, 112, and 114 are clients of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, network computers, laptop computers, handheld computers, and the like, with wire or wireless communication links to network 102. Also, it should be noted that each of clients 110, 112, and 114 is running a set of machine learning models on one or more data sets. The set of machine learning models may include any type or combination of machine learning models. Similarly, the data sets may be any type or combination of data sets. Subscribing users of clients 110, 112, and 114 may utilize clients 110, 112, and 114 to request the machine learning model management services provided by server 104 and server 106.

Storage 108 is a network storage device capable of storing any type of data in a structured format or an unstructured format. In addition, storage 108 may represent a plurality of network storage devices. Further, storage 108 may store identifiers and network addresses for a plurality of different client devices, a plurality of different machine learning models, metrics corresponding to the plurality of different machine learning models, subscribing user profiles that include corresponding machine learning models, model metrics, user-specified metric preferences, and the like. Furthermore, storage 108 may store other types of data, such as authentication or credential data that may include usernames and passwords associated with subscribing users, for example.

In addition, it should be noted that network data processing system 100 may include any number of additional servers, clients, storage devices, and other devices not shown. Program code located in network data processing system 100 may be stored on a computer-readable storage medium or a set of computer-readable storage media and downloaded to a computer or other data processing device for use. For example, program code may be stored on a computer-readable storage medium on server 104 and downloaded to client 110 over network 102 for use on client 110.

In the depicted example, network data processing system 100 may be implemented as a number of different types of communication networks, such as, for example, an internet, an intranet, a wide area network (WAN), a local area network (LAN), a telecommunications network, or any combination thereof. FIG. 1 is intended as an example only, and not as an architectural limitation for the different illustrative embodiments.

As used herein, when used with reference to items, “a number of” means one or more of the items. For example, “a number of different types of communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

With reference now to FIG. 2, a diagram of a data processing system is depicted in accordance with an illustrative embodiment. Data processing system 200 is an example of a computer, such as server 104 in FIG. 1, in which computer-readable program code or instructions implementing the machine learning model management processes of illustrative embodiments may be located. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. As used herein, a computer-readable storage device or a computer-readable storage medium is any piece of hardware that is capable of storing information, such as, for example, without limitation, data, computer-readable program code in functional form, and/or other suitable information either on a transient basis or a persistent basis. Further, a computer-readable storage device or a computer-readable storage medium excludes a propagation medium, such as transitory signals. Furthermore, a computer-readable storage device or a computer-readable storage medium may represent a set of computer-readable storage devices or a set of computer-readable storage media. Memory 206, in these examples, may be, for example, a random-access memory (RAM), or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

In this example, persistent storage 208 stores machine learning model manager 218. However, it should be noted that even though machine learning model manager 218 is illustrated as residing in persistent storage 208, in an alternative illustrative embodiment, machine learning model manager 218 may be a separate component of data processing system 200. For example, machine learning model manager 218 may be a hardware component coupled to communication fabric 202 or a combination of hardware and software components. In another alternative illustrative embodiment, a first set of components of machine learning model manager 218 may be located in data processing system 200 and a second set of components of machine learning model manager 218 may be located in a second data processing system, such as, for example, server 106 in FIG. 1. In yet another alternative illustrative embodiment, machine learning model manager 218 may be located in a client device, such as, for example, client 110 in FIG. 1, instead of, or in addition to, data processing system 200.

Machine learning model manager 218 controls the process of automatically identifying new machine learning models that are relevant to current machine learning models and have improved metrics over the current metrics of the current machine learning models running on data sets of client devices. In addition, machine learning model manager 218 determines whether a new machine learning model with improved metrics is compatible with a current machine learning model and its corresponding client device. If machine learning model manager 218 determines that the new machine learning model with improved metrics is compatible with the current machine learning model and its corresponding client device, then machine learning model manager 218 may automatically implement the new machine learning model with improved metrics in the corresponding client device to increase performance and notify the subscribing user of the implementation. Further, machine learning model manager 218 may compare the improved metrics of the new machine learning model with the current metrics of the current machine learning model and provide the subscribing user with a predicted performance increase of the new machine learning model over the current machine learning model based on the comparison of metrics. If machine learning model manager 218 determines that the new machine learning model with improved metrics is incompatible with the current machine learning model or its corresponding client device, then machine learning model manager 218 may send a recommendation to the subscribing user regarding the new machine learning model with improved metrics.

As a result, data processing system 200 operates as a special purpose computer system in which machine learning model manager 218 in data processing system 200 enables automatic identification and implementation of new machine learning models having improved metrics in client devices to improve performance of the client devices. In particular, machine learning model manager 218 transforms data processing system 200 into a special purpose computer system as compared to currently available general computer systems that do not have machine learning model manager 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer-readable program code that may be read and run by a processor in processor unit 204. The program instructions, in the different embodiments, may be embodied on different physical computer-readable storage devices, such as memory 206 or persistent storage 208.

Program code 220 is located in a functional form on computer-readable media 222 that is selectively removable and may be loaded onto or transferred to data processing system 200 for running by processor unit 204. Program code 220 and computer-readable media 222 form computer program product 224. In one example, computer-readable media 222 may be computer-readable storage media 226 or computer-readable signal media 228.

In these illustrative examples, computer-readable storage media 226 is a physical or tangible storage device used to store program code 220 rather than a medium that propagates or transmits program code 220. Computer-readable storage media 226 may include, for example, an optical or magnetic disc that is inserted or placed into a drive or other device that is part of persistent storage 208 for transfer onto a storage device, such as a hard drive, that is part of persistent storage 208. Computer-readable storage media 226 also may take the form of a persistent storage, such as a hard drive, a thumb drive, or a flash memory that is connected to data processing system 200.

Alternatively, program code 220 may be transferred to data processing system 200 using computer-readable signal media 228. Computer-readable signal media 228 may be, for example, a propagated data signal containing program code 220. For example, computer-readable signal media 228 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer-readable media 222” can be singular or plural. For example, program code 220 can be located in computer-readable media 222 in the form of a single storage device or system. In another example, program code 220 can be located in computer-readable media 222 that is distributed in multiple data processing systems. In other words, some instructions in program code 220 can be located in one data processing system while other instructions in program code 220 can be located in one or more other data processing systems. For example, a portion of program code 220 can be located in computer-readable media 222 in a server computer while another portion of program code 220 can be located in computer-readable media 222 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 220.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

In today's world of artificial intelligence, it is a challenge to keep track of all the new machine learning models and maintain their metrics (e.g., scores, measurements, and the like) corresponding to each one of the models. Machine learning model metrics may include, for example, at least one of precision, recall, F1 score, F2 score, transparency, explainability, and the like. Precision or accuracy is the fraction of relevant instances among retrieved instances. Recall or sensitivity is the fraction of relevant instances that were retrieved. Therefore, both precision and recall are based on relevance. Relevance means how well a retrieved instance (e.g., document) or set of instances meets the needs of a user. The F1 score is the harmonic mean of precision and recall. The F2 score weights recall higher than precision. Explainability is the extent to which the internal mechanics of a machine learning model can be explained in human terms. In other words, explainability allows a human to understand how and why the machine learning model achieved its outcome given the input. Transparency is the ability to know the reasoning behind the decision and the ability to explain that reasoning. In other words, transparency is the ability to know and explain what the machine learning model has learned and how the model used what it learned to reach its output.

Based on which machine learning model metrics the user wants to improve in the user's current machine learning system, the user can take appropriate action to apply or remove machine learning models. Some machine learning models may be supervised models that depend on particular datasets. However, in some instances, machine learning models may need to find patterns and relationships in datasets that may be semi-supervised or unsupervised models.

Illustrative embodiments automatically track new machine learning models, along with their metrics, that are relevant to current machine learning models running on data sets of respective users. In addition, illustrative embodiments maintain a mapping of the type of machine learning model needed for each particular data set of the users, along with a list of the different types of metrics corresponding to each respective machine learning model. Further, illustrative embodiments automatically and iteratively search for new machine learning models with improved metrics per respective user-specified metric preferences and then either automatically implement a new machine learning model with improved user-specified metrics when the new machine learning model is compatible with the current machine learning model of a user or recommend the new machine learning model to the user for implementation when the new machine learning model is incompatible with the current machine learning model. Illustrative embodiments also keep users informed regarding new metrics, which may have the potential to improve machine learning models.

Furthermore, illustrative embodiments automatically generate an extensible machine learning model catalog or database, which captures functional and nonfunctional factors of respective machine learning models, along with their machine learning model metrics. Functional factors are directly related to machine learning model performance and may include, for example, accuracy (e.g., precision, recall, and the like) of a given machine learning model. Nonfunctional factors are not directly related to machine learning model performance and may include, for example, transparency, explainability, how long it takes to train a particular machine learning model, deployment environment, and the like. The machine learning model catalog also maps the machine learning models against corresponding use cases and whether respective machine learning models are supervised, semi-supervised, or unsupervised machine learning models. Further, the machine learning model catalog maintains a user profile, which contains current machine learning models with corresponding current metrics of a given user, use case of each respective machine learning model, data sets of the user, user-specified preferences regarding certain machine learning model metrics the user wants improved, and the like, for each respective user. Based on information in a given user profile, illustrative embodiments can recommend a new machine learning model with improved metrics to the user. Illustrative embodiments also compare the current metrics of the current machine learning model with the improved metrics of the new machine learning model. Based on the comparison of the current to improved metrics, illustrative embodiments can provide an estimation of the new machine learning model's expected performance improvement over the current machine learning model, along with a rationale as to why the new model should be preferred over the current model.

Illustrative embodiments define each current or existing machine learning model on a user's data processing system based on a set of parameters. The set of parameters include, for example, artificial intelligence domain for a machine learning model utilized by a user, technology of the machine learning model, type of the machine learning model, library needed for the machine learning model, current version of the library being used for the machine learning model, user-specified metric parameters, and the like. Illustrative embodiments generate a bucket for each unique set of parameters corresponding to a machine learning model of a particular user. In addition, illustrative embodiments automatically capture parameters at various stages of a machine learning model's evolution over time.

As an illustrative example, if a user is utilizing a machine learning model that identifies whether cats or dogs are contained within an image, such as a picture or video, then illustrative embodiments may generate a bucket for the following unique combination of parameters: artificial intelligence domain {computer vision}/model technology {convolutional neural network}/model type {binary}/model library {Keras}/library version {#}. The first parameter is regarding the high-level class of artificial intelligence being used by the user. The user wants a current machine learning model for that class of artificial intelligence. Because this example is an image classification problem, the first parameter for the high-level class of artificial intelligence being used is computer vision. Thus, the first parameter in this example indicates that this is a computer vision-related problem. For a language understanding use case, the first parameter may be, for example, natural language processing.

The second parameter is regarding the technology of the machine learning model being used to solve the image classification problem. In this example, a convolutional neural network is being used for the image classification problem. For a language understanding use case, the second parameter may be, for example, a bidirectional encoder representations from transformers model.

The third parameter is regarding the type of machine learning model being used to solve the image classification problem. The same deep learning technology can manifest itself into multiple categories indicating whether the machine learning model is, for example, a binary classifier, a regression-based classifier that predicts a value, a series prediction such as a recurrent neural network, or the like. In this example, the underlying technology is a convolutional neural network that manifests itself in the form of a binary classifier indicating whether the image contains cats or dogs.

The fourth parameter is regarding the library needed for the machine learning model. The fourth parameter specifies the kind of open source technologies the user wants or needs for the machine learning model. For example, if illustrative embodiments discover that a new Tensorflow library for the machine learning model is available, then illustrative embodiments may determine that the new Tensorflow library is of no use to the user because the machine learning model's codebase was written in Keras. Thus, the fourth parameter defines which library the user needs for the machine learning model. In this example, illustrative embodiments search for a library written in Keras.

The fifth parameter is regarding the current version number of the library being used for the machine learning model. In this example, the current library version is 2.3.0. Assume, illustrative embodiments discover that a newer library version is now available (e.g., 2.3.1). However, this newer version has few features that the user wants or needs for the machine learning model. As a result, illustrative embodiments continue to search for an improved version of the library that meets the user's needs.

The sixth parameter is user-specified metric parameters. The user-specified metric parameters are additional parameters that illustrative embodiments take into consideration when searching for improved machine learning models. For example, the new machine learning model 2.3.1 has improved metrics regarding precision and performance over the 2.3.0 model, but the new machine learning model 2.3.1 is not improved with regard to recall and transparency metrics. The user specified a preference regarding which particular machine learning model metrics the user wants or needs to be improved in the current machine learning model. For example, the user specified that the user wants a recommendation of a new machine learning model only if the recall and transparency metrics of the new machine learning model are improved over the current machine learning model being utilized by the user. As a result, in this example, illustrative embodiments will not recommend new machine learning model 2.3.1 to the user but will recommend to the user new machine learning model 2.3.2 that has improved recall and transparency metrics.

Further, illustrative embodiments may automatically learn user-specified metric parameters over time. For example, the user has previously specified preferences for improved recall and transparency metrics in the use case of computer vision image classification-based machine learning models. Illustrative embodiments are capable of retaining the user-specified preferences for certain machine learning model metrics and automatically generate recommendations for the user. For example, for a computer vision binary classification-based machine learning model, which does not distinguish between cats and dogs but distinguishes between lions and tigers, illustrative embodiments may recommend a similar set of parameters and indicate that the user may be interested in a newer machine learning model only when the recall and transparency metrics are improved over the current machine learning model. As a result, illustrative embodiments take a comparative approach to what has been done in the past.

Thus, illustrative embodiments provide one or more technical solutions that overcome a technical problem with identifying and implementing new machine learning models with improved metrics over current metrics of current machine learning models. As a result, these one or more technical solutions provide a technical effect and practical application in the field of artificial intelligence.

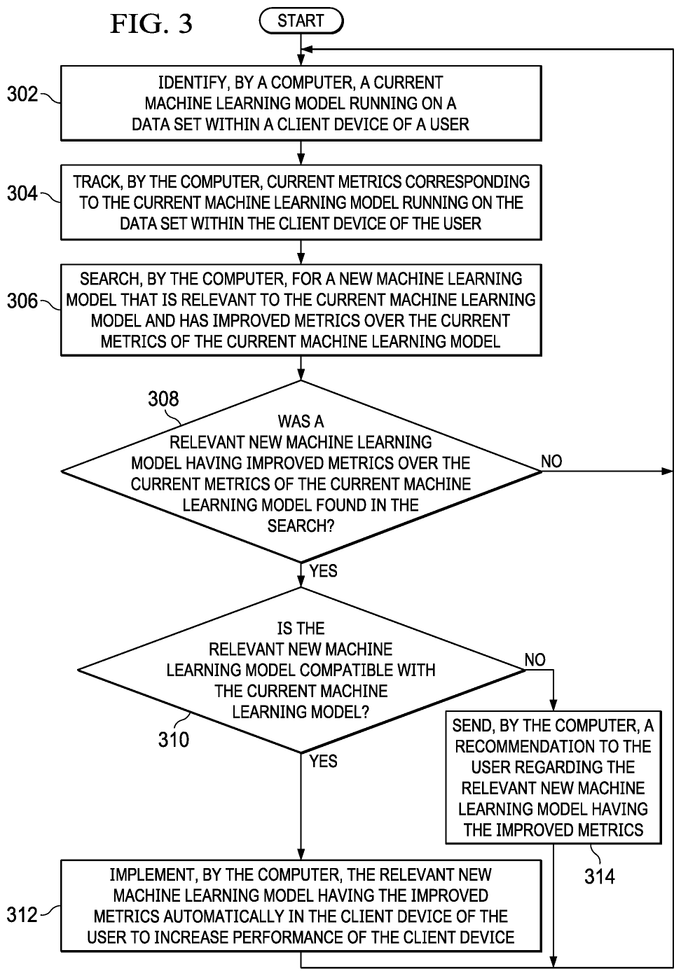

With reference now to FIG. 3, a flowchart illustrating a process for identifying new machine learning models with improved metrics is shown in accordance with an illustrative embodiment. The process shown in FIG. 3 may be implemented in a computer, such as, for example, server 104 in FIG. 1 or data processing system 200 in FIG. 2. For example, the process shown in FIG. 3 may be implemented in machine learning model manager 218 in FIG. 2.

The process begins when the computer identifies a current machine learning model running on a data set within a client device of a user (step 302). The client device may be, for example, client 110 in FIG. 1. The computer also tracks current metrics corresponding to the current machine learning model running on the data set within the client device of the user (step 304). In addition, the computer searches for a new machine learning model that is relevant to the current machine learning model and has improved metrics over the current metrics of the current machine learning model (step 306).

The computer makes a determination as to whether a relevant new machine learning model having improved metrics over the current metrics of the current machine learning model was found in the search (step 308). If the computer determines that no relevant new machine learning model having improved metrics over the current metrics of the current machine learning model was found in the search, no output of step 308, then the process returns to step 302 where the computer identifies a current machine learning model running on a data set within the client device of the user. If the computer determines that a relevant new machine learning model having improved metrics over the current metrics of the current machine learning model was found in the search, yes output of step 308, then the computer makes a determination as to whether the relevant new machine learning model is compatible with the current machine learning model (step 310).

If the computer determines that the relevant new machine learning model is compatible with the current machine learning model, yes output of step 310, then the computer automatically implements the relevant new machine learning model having the improved metrics in the client device of the user to increase performance of the client device (step 312) and notifies the user of the automatic implementation. Thereafter, the process returns to step 302. If the computer determines that the relevant new machine learning model is not compatible with the current machine learning model, no output of step 310, then the computer sends a recommendation to the user regarding the relevant new machine learning model having the improved metrics (step 314). Thereafter, the process returns to step 302.

Thus, illustrative embodiments of the present invention provide a computer-implemented method, computer system, and computer program product for identifying and implementing new machine learning models with improved metrics. The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for identifying new machine learning models with improved metrics, the computer-implemented method comprising:
searching, by a computer, for a new machine learning model that is relevant to a current machine learning model running on a data set within a client device of a user and that has improved metrics over current metrics of the current machine learning model;
determining, by the computer, whether a relevant new machine learning model having improved metrics over the current metrics of the current machine learning model was found in the searching;
responsive to the computer determining that a relevant new machine learning model having improved metrics over the current metrics of the current machine learning model was found in the searching, determining, by the computer, whether the relevant new machine learning model is compatible with the current machine learning model; and
responsive to the computer determining that the relevant new machine learning model is compatible with the current machine learning model, implementing, by the computer, the relevant new machine learning model having the improved metrics automatically in the client device of the user to increase performance of the client device.

2. The computer-implemented method of claim 1 further comprising:
responsive to the computer determining that the relevant new machine learning model is not compatible with the current machine learning model, sending, by the computer, a recommendation to the user regarding the relevant new machine learning model having the improved metrics.

3. The computer-implemented method of claim 1 further comprising:
identifying, by the computer, the current machine learning model running on the data set within the client device of the user; and
tracking, by the computer, the current metrics corresponding to the current machine learning model running on the data set within the client device of the user.

4. The computer-implemented method of claim 1, wherein the computer compares the improved metrics of the relevant new machine learning model with the current metrics of the current machine learning model and provides the user with a predicted performance increase of the relevant new machine learning model over the current machine learning model based on comparison of the improved metrics with the current metrics.

5. The computer-implemented method of claim 1, wherein the current metrics include at least one of precision, recall, F1 score, F2 score, transparency, and explainability.

6. The computer-implemented method of claim 1, wherein the improved metrics are user-specified metrics.

7. The computer-implemented method of claim 1, wherein the computer maintains a mapping of type of machine learning model needed for each particular data set of the user and a list of different types of metrics corresponding to each respective machine learning model.

8. The computer-implemented method of claim 1, wherein the computer maintains a user profile that contains current machine learning models with corresponding current metrics of the user, use case of each respective machine learning model, data sets of the user, and user-specified preferences regarding certain machine learning model metrics the user wants improved, and wherein the computer recommends new machine learning models with improved metrics to the user based on the user profile.

9. The computer-implemented method of claim 1, wherein the computer defines the current machine learning model based on a set of parameters that includes artificial intelligence domain for the current machine learning model, technology of the current machine learning model, type of the current machine learning model, library needed for the current machine learning model, and current version of the library being used for the current machine learning model.

10. A computer system for identifying new machine learning models with improved metrics, the computer system comprising:
a bus system;
a storage device connected to the bus system, wherein the storage device stores program instructions; and
a processor connected to the bus system, wherein the processor executes the program instructions to:
search for a new machine learning model that is relevant to a current machine learning model running on a data set within a client device of a user and that has improved metrics over current metrics of the current machine learning model;
determine whether a relevant new machine learning model having improved metrics over the current metrics of the current machine learning model was found in the search;
determine whether the relevant new machine learning model is compatible with the current machine learning model in response to determining that a relevant new machine learning model having improved metrics over the current metrics of the current machine learning model was found in the search; and
implement the relevant new machine learning model having the improved metrics automatically in the client device of the user to increase performance of the client device in response to determining that the relevant new machine learning model is compatible with the current machine learning model.

11. The computer system of claim 10, wherein the processor further executes the program instructions to:
send a recommendation to the user regarding the relevant new machine learning model having the improved metrics in response to determining that the relevant new machine learning model is not compatible with the current machine learning model.

12. The computer system of claim 10, wherein the processor further executes the program instructions to:
identify the current machine learning model running on the data set within the client device of the user; and
track the current metrics corresponding to the current machine learning model running on the data set within the client device of the user.

13. The computer system of claim 10, wherein the improved metrics of the relevant new machine learning model are compared with the current metrics of the current machine learning model and the user is provided with a predicted performance increase of the relevant new machine learning model over the current machine learning model based on comparison of the improved metrics with the current metrics.

14. The computer system of claim 10, wherein the current metrics include at least one of precision, recall, F1 score, F2 score, transparency, and explainability.

15. A computer program product for identifying new machine learning models with improved metrics, the computer program product comprising a computer-readable storage medium having program instructions embodied therewith, the program instructions executable by a computer to cause the computer to perform a method of:
searching, by the computer, for a new machine learning model that is relevant to a current machine learning model running on a data set within a client device of a user and that has improved metrics over current metrics of the current machine learning model;
determining, by the computer, whether a relevant new machine learning model having improved metrics over the current metrics of the current machine learning model was found in the searching;
responsive to the computer determining that a relevant new machine learning model having improved metrics over the current metrics of the current machine learning model was found in the searching, determining, by the computer, whether the relevant new machine learning model is compatible with the current machine learning model; and
responsive to the computer determining that the relevant new machine learning model is compatible with the current machine learning model, implementing, by the computer, the relevant new machine learning model having the improved metrics automatically in the client device of the user to increase performance of the client device.

16. The computer program product of claim 15 further comprising:
responsive to the computer determining that the relevant new machine learning model is not compatible with the current machine learning model, sending, by the computer, a recommendation to the user regarding the relevant new machine learning model having the improved metrics.

17. The computer program product of claim 15 further comprising:
identifying, by the computer, the current machine learning model running on the data set within the client device of the user; and
tracking, by the computer, the current metrics corresponding to the current machine learning model running on the data set within the client device of the user.

18. The computer program product of claim 15, wherein the computer compares the improved metrics of the relevant new machine learning model with the current metrics of the current machine learning model and provides the user with a predicted performance increase of the relevant new machine learning model over the current machine learning model based on comparison of the improved metrics with the current metrics.

19. The computer program product of claim 15, wherein the current metrics include at least one of precision, recall, F1 score, F2 score, transparency, and explainability.

20. The computer program product of claim 15, wherein the improved metrics are user-specified metrics.
